(19) United States
(12) Patent Application Publication
(10) Pub. No.: US 2008/0170986 A1
(43) Pub. Date: Jul. 17, 2008

(54) Zeolite Including Oxygen-Activated Metal Complex And Gas Decomposition Agent

(76) Inventors: Hideki Kitamura, Obu-shi (JP); Hideki Masuda, Okazakl-shi (JP); Nayumi Ohata, Nagoya-shi (JP); Yurie Ito, Nissin-shi (JP); Masashi Uchida, Komaki-shi (JP); Yasuo Kurihara, Nagoya-shi (JP)

Correspondence Address: JACOBSON HOLMAN PLLC, 400 SEVENTH STREET N.W., SUITE 600, WASHINGTON, DC, 20004, US

(21) Appl. No.: 11/659,794

(22) PCT Filed: Aug. 8, 2005
(86) PCT No.: PCT/JP05/14503

§ 371 Date: Sep. 27, 2007

(30) Foreign Application Priority Data
Aug. 9, 2004 (JP) 2004-232398

(51) Int. Cl. C01B 39/02

(52) U.S. Cl. 423/700

(57) ABSTRACT

Provided are zeolite comprising a metal and an oxygen-activated metal complex, wherein the above oxygen-activated metal complex is included within a unit cell comprised in the above zeolite as well as a gas decomposition agent comprised of the above zeolite. Examples of the above oxygen-activated metal complex are phthalocyanine metal complex, a bis(salicylidene)-o-phenylenediamidinato metal complex and a metal complex comprising a cyclic tetrapyrrole compound as a ligand. Examples of metal of the above oxygen-activated metal complex are silver, copper, zinc, platinum, palladium, cobalt, iron, manganese, ruthenium and the like. The above gas decomposition agent has an effect capable of continuously decomposing gases that are harmful to the health or felt unpleasant by human.

This is a 371 of PCT/JP2005/014503 filed 8 Aug. 2005.

### TECHNICAL FIELD

The present invention relates to zeolite including an oxygen-activated metal complex within its unit cell that is suitable for use as a gas decomposition agent.

### BACKGROUND ART

Gases that are harmful to the health or felt unpleasant by human can be handled by: (1) masking with fragrances or the like, (2) physical adsorption with activated charcoal, or (3) chemical reaction with various chemical compounds. However, these methods only produce temporary effects; achieving a continuous effect requires maintenance by replacing an agent or the like.

It is desirable for an agent having a continuous effect in the daily living environment in decomposing gases that are harmful to the health or felt unpleasant by human to have a decomposing (catalyzing) action at ordinary temperature. For example, Japanese Unexamined Patent Publication (KOKAI) Heisei No. 11-169727 proposes the use of a titanium oxide photocatalyst as an agent for removing harmful gases. Since optical energy causes the titanium oxide photocatalyst to generate active oxygen, thereby decomposing gas components, achieving a continuous gas decomposition effect requires constant irradiation with light such as ultraviolet radiation.

On the other hand, Japanese Unexamined Patent Publication (KOKAI) Heisei No. 5-277167 and Japanese Unexamined Patent Publication (KOKAI) Nos. 2002-321912 and 2003-202145 disclose the use of metal phthalocyanine complexes as gas decomposition agents, that are adsorbed on the surface of a carrier such as zeolite. These utilize the decomposition properties of phthalocyanine on gases such as formaldehyde. However, many phthalocyanines having various metallic bonds are included together and thus cannot undergo adequate decomposition reactions. Therefore, there is a need for a gas decomposition agent having even greater gas decomposition performance.

Accordingly, it is an object of the present invention to provide a gas decomposition agent that is capable of continuously decomposing at ordinary temperatures gases that are harmful to the health or felt unpleasant by human.

Means for achieving the above-mentioned object are as follows:
[1] Zeolite comprising a metal and an oxygen-activated metal complex, characterized in that said oxygen-activated metal complex is included within a unit cell comprised in said zeolite.
[2] The zeolite according to [1], wherein said oxygen-activated metal complex is at least one selected from the group consisting of a phthalocyanine metal complex, a bis(salicylidene)-o-phenylenediamidinato metal complex and a metal complex comprising a cyclic tetrapyrrole compound as a ligand.
[3] The zeolite according to [1] or [2], wherein said zeolite includes 0.1 to 35 mass percent of the oxygen-activated metal complex within the unit cells.
[4] The zeolite according to any of [1] to [3], wherein said zeolite is zeolite X or zeolite Y.
[5] The zeolite according to any of [1] to [4], wherein the metal comprised in said zeolite comprises at least one selected from the group consisting of silver, copper, zinc, platinum and palladium.
[6] The zeolite according to any of [1] to [5], wherein the metal comprised in said oxygen-activated metal complex is at least one selected from the group consisting of cobalt, iron, manganese, ruthenium, titanium, vanadium, nickel, copper and cerium.
[7] A gas decomposition agent which is the zeolite according to any of [1] to [6].

According to the present invention, it is possible to continuously decompose various harmful gases and gases with unpleasant odors, such as VOCs and other organic solvents, hydrogen sulfide, trimethylamine, acetic acid, formaldehyde, nonenal, isovaleric acid and indole.

### BEST MODE FOR CARRYING OUT THE INVENTION

The present invention will be described in greater detail below.

The zeolite of the present invention comprises a metal and an oxygen-activated metal complex and is characterized in that the aforementioned oxygen-activated metal complex is included within a unit cell comprised in the aforementioned zeolite.

The zeolite is a porous, crystalline aluminosilicate containing ion-exchangeable cations. In addition to conventionally known crystalline aluminosilicates, the zeolite in the present invention also includes metallosilicates and phosphate-based porous crystals having similar crystalline structures. Such chemical compounds having similar crystalline structures are described in detail in the book released in July of 2000 entitled, “The Science and Industry of Zeolite,” (Yoshio ONO, Tateaki YASHIMA, put out by Kodansha).

The zeolite of the present invention comprises a metal and an oxygen-activated metal complex. The oxygen-activated metal complex is included within a unit cell comprised in the zeolite. In the present invention, the term “unit cell” is defined as a constituent structural unit of the zeolite skeleton structure. In the present invention, the term “oxygen-activated metal complex” refers to a metal complex capable of causing an oxidation reaction by causing molecular oxygen to assume an active state in the form of a hydroxy radical, super oxide, or the like.

In the zeolite including oxygen-activated metal complexes within the unit cells, a certain quantity of oxygen-activated metal complexes in a certain binding state are included. This makes it possible to maintain a high activity state for target gases, yielding extremely good gas decomposition performance.

The zeolite of the present invention preferably includes 0.1 to 35 mass percent, more preferably 1.0 to 8.0 mass percent, of oxygen-activated metal complex within its unit cells. The containment of the oxygen-activated metal complex at quantities falling within the aforementioned ranges yields a high gas decomposition capability. In particular, it is desirable for each unit cell of the zeolite of the present invention to contain a single molecule of oxygen-activated metal complex to achieve high chemical reactivity with the gas being decomposed.

The presence of the oxygen-activated metal complex within the zeolite can be confirmed by elemental analysis.

When measuring by elemental analysis the levels of carbon and nitrogen in the zeolite including oxygen-activated metal complexes within its unit cells, calculation yields a mole ratio that is almost the same as the theoretical mole ratio of carbon/nitrogen of the oxygen-activated metal complex. In this manner, it is possible to confirm that oxygen-activated metal complex is included in the zeolite. Further, the quantity of oxygen-activated metal complex included within the zeolite can be calculated from the quantities of nitrogen and carbon constituting the oxygen-activated metal complex that have been measured by elemental analysis and the quantity of zeolite including oxygen-activated metal complex.

The state in which the oxygen-activated metal complex is present in the zeolite can be determined by gas adsorption method.

The size of the zeolite unit cells is approximately 0.3 to 1.8 nm. This is about the same size as the oxygen molecules (about 0.3 nm) and nitrogen molecules (about 0.4 nm) present in air. Thus, under certain conditions, when oxygen or nitrogen molecules are adsorbed on zeolite not including oxygen-activated metal complex within its unit cells, the oxygen or nitrogen molecules adsorb not just to the surface of the zeolite, but also to the interior of the unit cells. The specific surface area of the zeolite (surface area per unit mass; unit: m²/g) can be calculated from the level of adsorption. The term “surface area” in this context includes not just the outer surface of the zeolite, but also the surface within the unit cells. When the specific surface areas of zeolite not including oxygen-activated metal complex and zeolite including such complex are measured under identical conditions by this measurement method, the value obtained for the zeolite not including oxygen-activated metal complex include the surface within the unit cells. In contrast, since oxygen-activated metal complex is present within the unit cells in zeolite including oxygen-activated metal complex, oxygen molecules do not enter in the unit cells and the level of adsorption is reduced by that amount. Based on this difference, it is possible to confirm that oxygen-activated metal complex is included within the unit cells of the zeolite.

Examples of the specific structure of the zeolite in the present invention are: large-pore zeolites in which the structural pore openings are comprised of 12 atoms, such as zeolite X and Y, gumerinite, zeolite β, mordenite, offretite, EMT, SAPO-37, and beryllophosphate X; extra-large-pore zeolites in which the structural pore openings are comprised of 14 or more atoms, such as cloverite; medium-pore zeolites in which the structural pore openings are comprised of 10 atoms, such as ferrierite, heulandite, and weinebeneite; and small-pore zeolites in which the structural pore openings are comprised of 8 or fewer atoms, such as analcime, chabazite, erionite, and zeolite A. Of these, zeolites X and Y, EMT, SAPO-37, and beryllophosphate X have preferred structures for including a single molecule of oxygen-activated metal complex per unit cell because they have an internal pore diameter of 1.3 nm and an opening with a diameter of 0.7 nm.

Zeolites X and Y are particularly desirable from the viewpoint of the ease of synthesizing zeolite including an oxygen-activated metal complex at a position within the zeolite skeleton facilitating the decomposition of gases.

In the present invention, examples of the metal contained in the zeolite are: silver, copper, zinc, platinum, palladium, aluminum, indium, tin, titanium, vanadium, chromium, manganese, iron, cobalt, nickel, ruthenium, osmium, rhodium, and iridium; alkali metals such as lithium, sodium, and potassium; alkali earth metals such as magnesium, calcium, and barium; and rare-earth metals such as lanthanum and cerium. The metal contained in the zeolite can be selected in consideration of the intensity with which it chemically reacts with the target gas. At least one metal selected from the group consisting of silver, copper, zinc, platinum, and palladium is desirably contained in the zeolite of the present invention. The greater the chemical reactivity to the target gas of the metal contained in the zeolite, the better the gas collecting property achieved, and it is thus possible to increase gas decomposition efficiency.

In the present invention, the desired metal can be incorporated into the zeolite by any of the following methods: employing ion exchange during a manufacturing stage at which the oxygen-activated metal complex is not yet included within the unit cells to cause the desired metal to be supported by the starting material zeolite; or, once the oxygen-activated metal complex has been introduced into the unit cells, using ion exchange to cause the desired metal to be secondarily supported. The aforementioned ion exchange can be conducted by immersing the zeolite in a solution containing the desired ions and stirring the mixture for a prescribed period at room temperature, for example. The quantity of desired metal introduced into the zeolite can be controlled by controlling the quantity of ions in the solution containing the zeolite and desired metal that is being reacted. From the viewpoint of the ability to decompose gas, the quantity of desired metal introduced into the zeolite of the present invention is preferably 0.01 to 10.0 mass percent, more preferably 0.1 to 5.0 mass percent.

Examples of the oxygen-activated metal complex included within the unit cells comprised in the zeolite are: phthalocyanine metal complexes, bis(salicylidene)-o-phenylenediamidinato metal complexes; metal complexes comprising a cyclic tetrapyrrole compound as a ligand; complexes in which a cyclic polyamine, polyphosphine, polythioether, polyether, or cyclic compound in which an element contained in one of these is substituted with nitrogen, sulfur, phosphorus, or oxygen is comprised as a ligand; complexes having a two-legged, tridentate ligand in the form of diethylenetriamine, or a three-legged, quadridentate ligand in the form of trispyridylmethylamine, NTA, triethanolamine or the like, having a nitrogen, phosphorus, sulfur and oxygen atom as starting point; complexes comprising a cyclic tetrapyrrole compound as a ligand; bis(salicylidene)-o-phenylenediaminato complexes; bis(salicylidene)ethylenediaminato complexes; bis(salicylidene)propylenediaminato complexes; bis(salicylidene)cyclohexanediaminato complexes; bis(1-methyl-3-oxobutylidene)ethylenediaminato complexes; and complexes comprising an amino acid such as histidine or leucine, 2,2′-bipyridine, 1,10-phenanthroline, or 1-methyl-1,3-butanedione as a ligand. Of these, due to high catalytic capability or chemical stability of the compound itself, the above oxygen-activated metal complex is desirably at least one selected from the group consisting of phthalocyanine metal complexes, bis(salicylidene)-o-phenylenediamidinato metal complexes, and metal complexes comprising a cyclic tetrapyrrole compound as a ligand. Phthalocyanine metal complexes are particularly preferred.

In the present invention, examples of phthalocyanine metal complexes that can be included within the zeolite unit cells are those denoted by the following general formula:

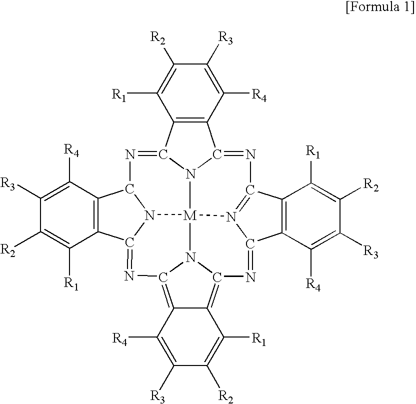

In the above general formula, R₁, R₂, R₃, and R₄ each independently denote hydrogen, an alkyl group, a substituted alkyl group, a halogen group, a nitro group, an amino group, a carboxyl group, a carboxylamide group, a nitrile group, a hydroxyl group, an alkoxyl group, a phenoxyl group, a sulfonic acid group, or a sulfonic acid amide group. Each of R₁ to R₄ may be selected in consideration of the size of the zeolite unit cells. Phthalocyanine metal complexes in which R₁ to R₄ all denote hydrogen are desirably incorporated into the unit cells of the zeolite of the present invention. Since the size of one molecule of a phthalocyanine metal complex in which R₁ to R₄ all denote hydrogen is almost the same as the size of the zeolite unit cell, the molecule can remain stably within the unit cell. Thus, a zeolite of high gas decomposition capability can be obtained by incorporating this type of phthalocyanine metal complex into unit cells.

In the present invention, cobalt, iron, manganese, ruthenium, titanium, vanadium, nickel, copper, and cerium are examples of the metal (M in the above general formula in the case of the phthalocyanine metal complex denoted by the above general formula) contained in the oxygen-activated metal complex. Of these, cobalt, iron, manganese, and ruthenium are preferred for the ease of synthesis and their high chemical reactivity as oxygen-activated metal complexes with gases to be decomposed. The quantity of metal contained in the oxygen-activated metal complex is preferably 0.01 to 10.0 mass percent, more preferably 0.2 to 2.0 mass percent. In the case of a phthalocyanine metal complex, the quantity of metal in the catalyst is fixed, so the ratio of phthalocyanine to metal in mole units is equal (1:1).

By way of example, the oxygen-activated metal complex can be introduced into the zeolite unit cells by heating the zeolite and an oxygen-activated metal complex precursor in a sealed tube, or by heating and refluxing them in solution.

An example of the use of a phthalocyanine metal complex in which R₁ to R₄ all denote hydrogen in the above general formula will be employed below to describe a method of introducing the phthalocyanine metal complex into the zeolite unit cells.

Zeolite including phthalocyanine metal complexes in its unit cells can be obtained by mixing the zeolite that has been subjected to ion exchange to support a desired metal or the zeolite prior to ion exchange with 1,2-dicyanobenzene and then heating the mixture in a sealed tube for 4 to 12 hours at 200 to 300 degree Celsius, for example. Here, the quantity of phthalocyanine metal complex included within the zeolite unit cells can be controlled by adjusting the proportions of the mixture of zeolite and 1,2-dicyanobenzene. Further, phthalocyanine metal complexes comprising desired metals can be formed within unit cells by charging desired cations in the sealed tube (for example, by employing starting material zeolite which has supported desired cations).

The mixing ratio (by mass) of the metal-supporting zeolite and 1,2-dicyanobenzene (zeolite:1,2-dicyanobenzene) is desirably from 1:0.7 to 1:1.8. Reaction conditions of 200 degree Celsius for 4 to 7 hours are desirable, with 200 degree Celsius for 4 to 6 hours being particularly preferred. The 1,2-dicyanobenzene is commercially available.

Following the above reaction, the zeolite is desirably washed with an organic solvent. This can remove unreacted 1,2-dicyanobenzene, by-products, and phthalocyanine metal complex that has formed on the exterior of the zeolite skeleton structure, making it possible to maintain the activity of the phthalocyanine metal complex and the adsorbing capability of the zeolite. Acetone, methanol, or pyridine is desirably employed as the organic solvent in washing. The temperature of the washing solution is desirably close to the boiling point of each solvent.

When introducing into the zeolite unit cells a phthalocyanine metal complex other than a phthalocyanine metal complex in which R₁ to R₄ in the above general formula all denote hydrogen atoms, it suffices to employ dicyanobenzene having corresponding substituents in the same operation as above.

The example of the introduction of an oxygen-activated metal complex in the form of a phthalocyanine metal complex into the zeolite unit cells has been described above. When employing oxygen-activated metal complexes other than phthalocyanine metal complexes, the catalyst can be introduced into the unit cells according to the above-described method.

The zeolite of the present invention can be employed as a gas decomposition agent. In the present invention, the term “gas decomposition agent” refers to an agent that is capable of continuously decomposing a chemical compound or component, such as a VOC or some other organic solvents, hydrogen sulfide, trimethylamine, acetic acid, formaldehyde, nonenal, isovaleric acid, indole, mercaptans, and thioethers that have unpleasant odors or are harmful. Examples of VOCs are formaldehyde, xylene, toluene, ethylbenzene, styrene monomer, and paradichlorobenzene, which have a high probability of causing influences such as sick house syndrome and sick school syndrome.

The zeolite of the present invention may also be employed as an oxidation catalyst. Specifically, it may be employed as a catalyst or the like to inexpensively synthesize large quantities of N-oxides suitable for use as cleaning agents by oxidizing amines, for example. When conducting a reaction employing the zeolite of the present invention as an oxidation catalyst, the catalytic reaction can be conducted by known methods and the quantity of catalyst employed can be suitably determined.

### EXAMPLES

The present invention will be described more in detail based on the examples.

### Example 1

### Preparation of Zeolite Including Phthalocyanine Metal Complex (Supporting Na)

A 100 g quantity of zeolite supporting 1 mass percent of cobalt was dried for 3 hours at 250 degree Celsius and mixed with 100 g of 1,2-diaminobenzene. The mixture was sealed within a glass tube and heated for 6 hours at 200 degree Celsius. After standing to cool, the solid obtained was washed for 48 hours with acetone, 48 hours with methanol, 120 hours with pyridine, and 24 hours with acetone in-a Soxhlet extractor to remove unreacted 1,2-dicyanobenzene, by-products, and cobalt-phthalocyanine metal complex that had formed outside the pores. The washed solid was immersed in a 5 mass percent sodium nitrate aqueous solution and stirred for 12 hours at room temperature to replace with sodium ions and eliminate cobalt that had remained without forming phthalocyanine metal complex within the zeolite skeleton. The solid was then dried overnight at 100 degree Celsius to obtain Na-supporting zeolite including cobalt-phthalocyanine metal complex. The amount of sodium supported by the above zeolite was determined by fluorescent X-ray measurement, yielding a result of 1 mass percent. The amount of cobalt in the phthalocyanine metal complex was determined by fluorescent X-ray measurement, yielding a result of 1.3 mass percent.

### Example 2

### Preparation of Zeolite Including Phthalocyanine Metal Complex (Supporting Ag)

A 10 g quantity of the zeolite including cobalt-phthalocyanine metal complex obtained in Example 1 was added to a solution obtained by dissolving 0.30 g of silver nitrate in 100 mL of water and the mixture was stirred overnight. The solid was filtered out, washed on a funnel with 100 mL of water and 20 mL of acetone, and dried overnight at 100 degree Celsius to obtain a 1 mass percent silver ion exchange product of zeolite including cobalt-phthalocyanine metal complex. The quantity of silver ions supported by the zeolite was determined by fluorescent X-ray measurement. The quantity of cobalt in the phthalocyanine metal complex was determined by fluorescent X-ray measurement, yielding a result of 0.9 mass percent.

### Example 3

### Preparation of Zeolite Including Phthalocyanine Metal Complex (Supporting Cu)

A 10 g quantity of the zeolite including cobalt-phthalocyanine metal complex obtained in Example 1 was added to a solution obtained by dissolving 0.28 g of copper (II) nitrate (tetrahydrate) in 100 mL of water and the mixture was stirred overnight. The solid was filtered out, washed on a funnel with 100 mL of water and 20 mL of acetone, and dried overnight at 100 degree Celsius to obtain a 1 mass percent copper ion exchange product of zeolite including cobalt-phthalocyanine metal complex. The quantity of copper ions supported by the zeolite was determined by fluorescent X-ray measurement. The quantity of cobalt in the phthalocyanine metal complex was determined by fluorescent X-ray measurement, yielding a result of 1.0 mass percent.

### Example 4

### Preparation of Zeolite Including Phthalocyanine Metal Complex (Supporting Zn)

A 10 g quantity of the zeolite including cobalt-phthalocyanine metal complex obtained in Example 1 was added to a solution obtained by dissolving 0.32 g of zinc nitrate (hexahydrate) in 100 mL of water and the mixture was stirred overnight. The solid was filtered out, washed on a funnel with 100 mL of water and 20 mL of acetone, and dried overnight at 100 degree Celsius to obtain a 1 mass percent zinc ion exchange product of zeolite including cobalt-phthalocyanine metal complex. The quantity of zinc ions supported by the zeolite was determined by fluorescent X-ray measurement. The quantity of cobalt in the phthalocyanine metal complex was determined by fluorescent X-ray measurement, yielding a result of 1.0 mass percent.

### Comparative Example 1

### Preparation of Cobalt-Phthalocyanine Metal Complex

A 100 g quantity of 1,2-dicyanobenzene was sealed in a glass tube and heated for 6 hours at 200 degree Celsius. After standing to cool, the solid obtained was washed for 48 hours with acetone, 48 hours with methanol, 120 hours with pyridine, and 24 hours with acetone in a Soxhlet extractor to remove unreacted 1,2-dicyanobenzene and by-products, yielding cobalt-phthalocyanine metal complex.

### Comparative Example 2

### Preparation of Zeolite on the Surface of which Cobalt-Phthalocyanine Complex Salt Adsorbed

Zeolite was immersed in an alcohol solution of phthalocyanine. The mixture was dried at 100 degree Celsius and then immersed in 0.5 N cobalt chloride solution (alcohol+water). The mixture was dried at 150 degree Celsius to prepare zeolite with cobalt-phthalocyanine metal complex adsorbed on its surface.

### [Determination of the State of the Phthalocyanine Metal Complex Existing]

### (1) Gas Adsorption Method

A P-700 BET specific surface area measuring device made by SIBATA SCIENTIFIC TECHNOLOGY, LTD. was employed to calculate the specific surface area of the zeolites prepared in Examples 1 to 4 and Comparative Example 2, and that of zeolite X (untreated product) from the oxygen gas adsorption level. The results are given in Table 1.

TABLE 1

| | Specific surface area |
|---|---|
| Sample | (m²/g) |
| Example 1 | 147 |
| Example 2 | 152 |
| Example 3 | 141 |
| Example 4 | 143 |
| Comp. Ex. 2 | 680 |
| Zeolite X | 672 |

The unit cells of zeolite X are about 0.3 to 1.8 nm in size. This is about the same size as an oxygen molecule (about 0.3 nm). When oxygen gas was adsorbed onto zeolite not including phthalocyanine metal complex within its unit cells, the oxygen molecules adsorbed onto the interior of the unit cells as well as onto the surface of the zeolite. Thus, the zeolite of Comparative Example 2 and zeolite X produced values of 600 m²/g order. Since the unit cells of the zeolites included phthalocyanine in Examples 1 to 4, they could not adsorb oxygen gas, and values of 140 to 150 m²/g order were exhibited. From the difference in the above results, it was determined that the zeolites obtained in Examples 1 to 4 included phthalocyanine metal complexes within their unit cells.

### (2) Elemental Analysis

The proportions based on mole of carbon content and nitrogen content in the zeolite obtained in Example 1 were measured with a 2400-II Perkin-Elmer Elemental Analyzer, revealing 2.30 percent for carbon and 0.57 percent for nitrogen. The theoretical mole ratio of carbon/nitrogen in phthalocyanine is 4.0; the ratio calculated from the measurement value obtained for the zeolite of Example 1 was 4.03, determining that the zeolite obtained in Example 1 included phthalocyanine metal complexes. The same method was employed to determine that phthalocyanine metal complexes were included within the zeolites obtained in Examples 2 to 4. When the amount of phthalocyanine metal complex included within the zeolites obtained in Examples 1 to 4 was calculated from the elemental analysis measurement values, the value was 3.3 mass percent for each.

### [Gas Decomposition Test]

Ethanol solution comprising 20 g/L of indole and that comprising 10 g/L of nonenal were prepared. Each of these solutions was charged to a gas preparation container in an amount of 70 microliters to prepare 7 L of initial gas. This gas was left standing for 2 hours and then placed in a 6 L Tedlar bag with 1 g of sample. Three hours later, the gas concentration was measured with a gas chromatography/mass spectrometer measurement device. The rate of reduction to the initial gas concentration was calculated from the area of the peak. A value of 100 percent means that none of the target gas was detected, indicating complete decomposition.

As will be understood from Tables 2 and 3, the zeolites of Examples 1 to 4 exhibited markedly better ability to decompose gas than did Comparative Example 1 (phthalocyanine metal complex) and Comparative Example 2 (zeolite with phthalocyanine metal complex adsorbed on its surface).

TABLE 2
Indole reduction rate

| | Three hours later |
|---|---|
| Example 1 | 60 percent |
| Example 2 | 100 percent |
| Example 3 | 100 percent |
| Example 4 | 100 percent |
| Comp. Ex. 1 | 20 percent |
| Comp. Ex. 2 | 29 percent |

TABLE 3
Nonenal reduction ratio

| | Three hours later |
|---|---|
| Example 1 | 72 percent |
| Example 2 | 84 percent |
| Example 3 | 94 percent |
| Example 4 | 85 percent |
| Comp. Ex. 1 | 15 percent |
| Comp. Ex. 2 | 32 percent |

### Example 5

### Preparation of Zeolite Including bis(salicylidene)-o-phenylenediaminato Metal Complex (Supporting Ag)

A 100 g quantity of zeolite supporting 1 mass percent of cobalt was dried for 3 hours at 250 degree Celsius and then added to 1 L of dry ethanol in which 50 g of o-phenylenediamine was dissolved. The mixture was then refluxed with heating for one hour. When the heating was stopped, 110 g of salicylaldehyde was added to the suspension and the mixture was refluxed for another two hours with heating. The suspension was filtered. The solid obtained was washed for 48 hours with dichloromethane and 24 hours with acetone in a Soxhlet extractor to remove the unreacted o-phenylenediamine, salicylaldehyde, and cobalt-bis(salicylidene)-o-phenylenediaminato complex formed outside the pores. The washed solid was immersed in a 5 mass percent sodium nitrate aqueous solution and stirred for 12 hours at room temperature to replace with sodium ions and eliminate the cobalt ions remaining in the zeolite skeleton without forming bis(salicylidene)-o-phenylenediaminato complex. The mixture was dried overnight at 100 degree Celsius, yielding zeolite supporting Na and including cobalt-bis(salicylidene)-o-phenylenediaminato complex.

A 10 g quantity of the zeolite supporting Na and including cobalt-bis(salicylidene)-o-phenylenediaminato complex was added to a solution obtained by dissolving 0.30 g of silver nitrate in 100 mL of water and the mixture was stirred overnight. The solid was filtered out, washed on a funnel with 100 mL of water, and dried overnight at 100 degree Celsius, yielding a 1 mass percent silver ion-exchange product of zeolite including cobalt-bis(salicylidene)-o-phenylenediaminato complex. The quantity of silver ions supported by the zeolite was determined by fluorescent X-ray measurement. The quantity of cobalt supported in the form of bis(salicylidene)-o-phenylenediaminato complex was determined by fluorescent X-ray measurement to be 0.8 mass percent.

A gas decomposition test was conducted by the same method as set forth above on the zeolite supporting Ag and including cobalt-bis(salicylidene)-o-phenylenediaminato complex obtained in Example 5 using indole as gas. The indole reduction rate was 0 percent at 0 hours, 86 percent at 1 hour, and 100 percent at 3 hours, confirming that the zeolite possessed excellent gas decomposition capability.

### INDUSTRIAL APPLICABILITY

The zeolite of the present invention can be employed to decompose and eliminate gases that are harmful to the health or felt unpleasant by human. The zeolite of the present invention can be kneaded into building materials such as wall materials, floor materials, and ceiling materials; materials for furniture such as chairs, tables, beds, and cabinets, and for the interior of vehicles such as automobiles and trains; and mixed into paints that are applied to building materials, for example. Further, the zeolite of the present invention is useful as an oxidation catalyst.

1. Zeolite comprising a metal and an oxygen-activated metal complex, characterized in that said oxygen-activated metal complex is included within a unit cell comprised in said zeolite.

2. The zeolite according to claim 1, wherein said oxygen-activated metal complex is at least one selected from the group consisting of a phthalocyanine metal complex, a bis(salicylidene)-o-phenylenediamidinato metal complex and a metal complex comprising a cyclic tetrapyrrole compound as a ligand.

3. The zeolite according to claim 1, wherein said zeolite includes 0.1 to 35 mass percent of the oxygen-activated metal complex within the unit cells.

4. The zeolite according to claim 1, wherein said zeolite is zeolite X or zeolite Y.

5. The zeolite according to claim 1, wherein the metal comprised in said zeolite comprises at least one selected from the group consisting of silver, copper, zinc, platinum and palladium.

6. The zeolite according to claim 1, wherein the metal comprised in said oxygen-activated metal complex is at least one selected from the group consisting of cobalt, iron, manganese, ruthenium, titanium, vanadium, nickel, copper and cerium.

7. A gas decomposition agent which is the zeolite according to claim 1.
